(19) United States
(12) Patent Application Publication
(10) Pub. No.: US 2010/0243775 A1
(43) Pub. Date: Sep. 30, 2010

(54) Safety Shredder

(75) Inventor: Liangneng Chen, Shanghai (CN)

Correspondence Address: WANG, HARTMANN & GIBBS, 1301 DOVE STREET, SUITE 1050, NEWPORT BEACH, CA, 92660, US

(73) Assignee: Aurora Office Equipment Co., Ltd., Shanghai (CN)

(21) Appl. No.: 12/794,720

(22) Filed: Jun. 4, 2010

Related U.S. Application Data
(63) Continuation of application No. 11/980,176, filed on Oct. 30, 2007, now Pat. No. 7,757,985.

(51) Int. Cl. B02C 23/00

(52) U.S. Cl. 241/37.5

(57) ABSTRACT

The present invention relates to providing active protection through a safe structure of a paper shredder. It comprises a paper shredder upper cover and a paper shredder plate disposed on the paper shredder upper cover. Different from prior art paper shredders, which are provided with independent safe switches, the paper shredder plate of the present invention, is configured with a touch structure and a safe power supply switch. When closed, the paper shredder plate prevents users from accidentally touching the shredding blade, and the like. Inside the paper shredder, it starts the paper shredder and guarantees the paper shredder's normal operation on the one hand, and prevents forced feeding of non-expected items on the other hand. In the later case, the structure disposed on the inner surface of the paper shredder plate provides dual protection and is capable of stopping the paper shredding from working, whereby the safety of users is enhanced.

### FIELD OF THE INVENTION

The present invention relates to a safe mechanism for use in a paper shredder. Specifically, it relates to a safety assurance mechanism, particularly a novel safe paper feed opening structure.

### BACKGROUND OF THE INVENTION

The currently paper feed openings of paper shredders can be divided into two types: one having an open structure, with which a user can directly feed paper into a paper feed opening for shredding; the other having a sliding-plate structure, with which a user needs to expose the paper feed opening first and feed paper in thereafter. Neither one of the two structures are directly connected to a circuit capable of cutting off power to the paper shredder. Therefore, neither paper teed opening type preferentially cuts off power to the paper shredder so as to actively protect users from accidentally feeding parts of their bodies or their personal belongings into a paper feed opening.

It is an objective of the present invention to overcome the defects of the above discussed prior art by providing a novel safe paper feed opening structure for a paper shredder. This paper feed opening structure is very simply, cleverly designed, and is easy to use; it features active protection and dual protection. Due to these characteristics, this structure is very safe and very economical.

### SUMMARY OF THE INVENTION

To realize the above mentioned objective, the circuit design and the mechanical structure of the present invention, namely the novel safe paper feed opening structure, possess the following technical features: a novel safe paper feed opening structure comprising a paper shredder upper cover and a paper shredder plate, the shredder upper cover having an opening, and the paper shredder plate being disposed at the opening. The paper shredder upper cover and the paper shredder plate are either integrated or separated, wherein the paper shredder plate is configured with a touch structure/safe power supply switch, and the paper shredder upper cover is correspondingly configured with a safe power supply switch/touch structure. The touch structure and the safe power supply switch are designed to interact with each other, so that the power supply is cut off when the paper shredder plate is closed, is connected when the paper shredder plate is open, and is cut off when non-expected items are fed in.

Therefore, the safe power supply switch has a dual protection function: when the paper shredder plate is closed, the entire circuit is not electrically conductive—this is the first-level protection; while when the paper shredder plate is opened during normal operation, the paper shredder plate will cut off the power supply if there are any non-expected items fed in or that accidentally fall down. The falling action will cause a noticeable three that enables the safe power supply switch to cut off power supply—this is the second-level protection.

The touch structure and the safe power supply switch are integrated into one circuit disconnection device that serves as protection means which actively cuts off the power supply whenever a non-expected item is fed in, and which functions reversely as a passive conducting device when paper is fed at the paper feed opening. The safe power supply switch is a preferential disconnection device. Different from a safe switch or a paper-full switch, whose function is realized by adopting a flip-flop in a paper shredder circuit, the safe power supply switch has first-level priority to protect a user.

The paper shredder upper cover and the paper shredder plate refer to any separate or integrated structures able to seal the paper feed opening. The paper shredder plate and the paper shredder upper cover are connected such that the former can move separately relative to the latter. The touch structure is a cam disposed on the paper shredder plate; corresponding to the cam, the safe power supply switch is disposed on a corresponding position of the paper shredder upper cover. The cam and the safe power supply switch are configured to interact with each other.

The opening is a dented opening disposed on the paper shredder upper cover; the paper shredder plate locates at the dented opening; the cam is disposed on the inner surface of the paper shredder plate; and the safe power supply switch is disposed inside the paper shredder upper cover.

The cam comprises a fundamental cam and a earn point on the fundamental cam. The fundamental cam is fixed on the paper shredder plate, and the cam point interacts with the touch point of the safe power supply switch.

Shaft bases are fixed on the two opposite sides inside the paper shredder upper cover. The shaft bases each comprise a main base body and a shaft protruding from the main base body. Corresponding to the shaft base, protruding blocks are fixed on the opposite sides of the inner surface of the paper shredder plate. Within each protruding blocks, a shaft hole is opened to accommodate the shaft.

The shaft base further comprises protrusions each located under the shaft and provided with a protruding point pointing towards the shaft. To match the protruding points, a closing detent point and a working detent point are provided on each protruding block; the protruding point is accommodated in either the closing deem point or the working detent point.

The fundamental cam is fixed to the protruding block, whereby the cam is indirectly fixed to the paper shredder plate. The main base bodies each have through holes. The opposite sides inside the paper shredder upper cover are configured with poles. The holes and the poles are connected together by screws that go through both.

Of the two opposite sides of the paper shredder plate, one side is configured at its inner surface with a paper stopper that extends downwards and inwards, and the other side is designed with a dent pressing area in the middle section of the outer surface.

The safe power supply switch includes through holes. Inside, the paper shredder upper cover has poles at the place corresponding to the touch structure. The holes and the poles are connected together by screws that go through both.

A common protection circuit of a prior art paper shredder is roughly composed of a safe switch (trash can touch switch), a paper-full switch (or a photic-controlled paper-full switch), and a power supply flip-flop (or a microcomputer-controlled inching switch). When the paper shredder detaches from a trash can, or when the trash can is full, the safe switch and the paper-full switch have the first-level priority to cut off the power supply for protection of a user. Of course, adding a switch with pure cutting-off function before the aforesaid switches, or pulling off a power supply switch, also has protection effect. In the circuit of the present invention, namely a novel safe paper feed opening structure of a paper shredder, a disconnection switch which has first-level priority is introduced before a safe switch and a paper-full switch. In other words, the present invention adopts a safe power supply switch that provides more active protection to users with the aid of a mechanical structure.

### Beneficial Effects of the Present Invention Include

1. The present invention adopts a paper shredder plate that enables a touch structure and a safe power supply switch to interact with each other. The structure of the utility is simple, and prior art paper shredders only need to be partially improved. The manufacturing cost is low.

2. The present invention adopts a touch structure and a safe power supply switch to interact with each other, so as to control the opening and closing of the paper shredder plate and the switching on and off of the power supply to the paper shredder. Moreover, in ease of abnormal opening of the paper shredder plate, power supply will be cut off to prevent any part of a user's body or his/her personal belongings to enter the paper feed opening. Obviously, the present invention has the functions of active protection and dual protection—it protects the safety of a user and is very safe.

3. The present invention provides the protruding block with a flexible closing detent point and a flexible working point, either one of which matches the protruding point on the shaft base, and enables accurate closing and opening of the paper shredder plate. It is very convenient.

### BRIEF DESCRIPTION OF THE DRAWINGS

The invention is generally shown by way of reference to the accompanying drawings in which:

FIG. 1 shows the cross-section of an embodiment of the present invention;

FIG. 2 shows the 3-Dimensional structure of the shaft base of the embodiment shown in FIG. 1;

FIG. 3 shows the 3-Dimensional structure of the cover plate of the embodiment shown in FIG. 1;

FIG. 4 shows the 3-Dimensional structure of the assembling process of the embodiment shown in FIG. 1;

FIG. 5 shows the 3-Dimensional structure of a finished assembly shown in FIG. 4;

FIG. 6 shows the 3-Dimensional structure of a part of a cross-section of the embodiment shown in FIG. 5; and

FIG. 7 shows the 3-Dimensional structure of a part of another cross-section of the embodiment shown in FIG. 5;

FIG. 8 shows the cross-section of an open paper shredder plate of the embodiment shown in FIG. 1;

FIG. 9 shows the cross-section of the paper shredder plate in abnormal status of the embodiment shown in FIG. 1;

FIG. 10 shows the priority of a protection circuit in prior art; and

FIG. 11 shows the priority levels of the safe power supply switch of the present utility.

### DETAILED DESCRIPTION OF THE INVENTION

The following embodiment will explain the technical details of the present invention to make it more easily understood.

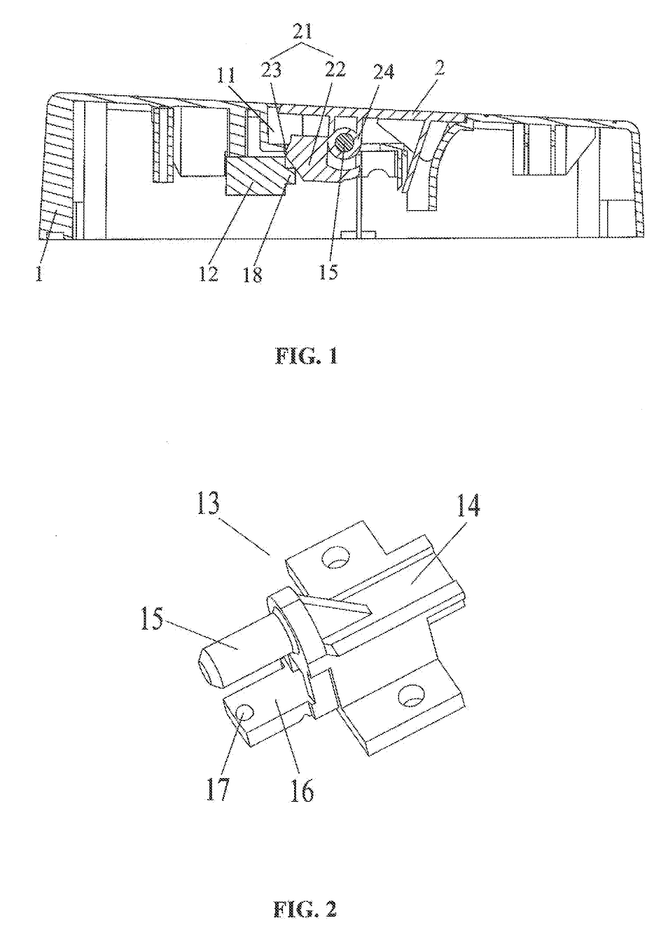

Referring to FIG. 1, the present invention relates to a novel safe paper feed opening structure of a paper shredder, comprising a paper shredder upper cover 1 and a paper shredder paper shredder plate 2, the paper shredder upper cover 1 having an opening, and the paper shredder plate 2 being disposed at the opening. The paper shredder upper cover 1 and the paper shredder plate 2 may be either integrated or separated.

The paper shredder plate 2 is configured with a touch structure, and the paper shredder upper cover 1 is correspondingly configured with a safe power supply switch 12. The touch structure and the safe power supply switch 12 are designed to interact with each other, meaning that when the paper shredder plate 2 is closed, the touch structure acts on the safe power supply switch 12 so as to cut oft the power supply. When the paper shredder plate 2 is opened, the touch structure acts on the safe power supply switch 12 to allow power. When there is any non-expected item fed in, the non-expected item forces the paper shredder plate 2 up, hence causing the touch structure to act on the safe power supply switch 12 to actively cut off the power supply.

With the above technical features, the safe power supply switch 12 has a dual protection function: when the paper shredder plate 2 is closed, the entire circuit is not electrically conductive—this is the first-level protection. When the paper shredder plate is opened during normal operation, the paper shredder plate will cut off the power supply if there are any non-expected items fed in or that accidentally fall into the opening as they will cause a noticeable force that enables the safe power supply switch 12 to cut off power supply—this is the second-level protection.

The touch structure and the safe power supply switch 12 are integrated into one circuit disconnection device that serves as a protection system which actively cuts off the power supply whenever a non-expected item is fed in, and which functions reversely as a passive conducting device while feeding paper through the paper feed opening. The safe power supply switch 12 is a preferential disconnection device. Different from a safe switch or a paper-full switch, whose function is realized by adopting a flip-flop in a circuit of a paper shredder, the safe power supply switch 12 has first-level priority to protect a user.

The paper shredder upper cover 1 and the paper shredder plate 2 refer to any separate or integrated structures able to seal the paper feed opening. The paper shredder plate 2 and the paper shredder upper cover 1 are connected such that the former can move separately relative to the latter. The touch structure is a cam 21 disposed on the paper shredder plate 2. Corresponding to the cam 21, the safe power supply switch 12 is disposed on a corresponding position of the paper shredder upper cover 1. The cam 21 and the safe power supply switch 12 are configured to interact with each other. That is, when the paper shredder plate 2 is opened, the cam 21 acts on the safe power supply switch 12 so as to switch on the safe power supply switch 12. When there is any non-expected item fed in, the cam 21 acts on the safe power supply switch 12 to cut off the safe power supply switch 12 actively. When the paper shredder plate 2 is closed, the cam 21 functions on the safe power supply switch 12 again and cuts it off.

In one of the embodiments of the present invention, the opening is a dented opening 11 disposed on the paper shredder upper cover 1; the paper shredder plate 2 locates at the dented opening 11; the cam 21 is disposed on the inner surface of the paper shredder plate 2; and the safe power supply switch 12 is disposed inside the paper shredder upper paper shredder upper cover 1.

The cam 21 comprises a fundamental cam 22 and a cam point 23 on the fundamental cam 22. The fundamental cam 22 is coupled to the paper shredder plate 2, and the cam point 23 interacts with the touch point 18 of the safe power supply switch 12. That is, during the process of opening the paper shredder plate 2, the cam point 23 of the cam 21 acts on the touch point 18 of the safe power supply switch 12 so as to switch on the safe power supply switch 12. When there is any non-expected item fed in, the cam point 23 of the cam 21 acts on the touch point 18 of the safe power supply switch 12 to cut off the safe power supply switch 12 actively. When the paper shredder plate 2 is closed, the cam point 23 of the cam 21 acts on the touch point 18 of the safe power supply switch 12 again and cuts it off. In other words, the current circuit is switched on and off when the touch point 18 of the safe power supply switch 12 is pressed by the cam 21 of the paper shredder plate 2.

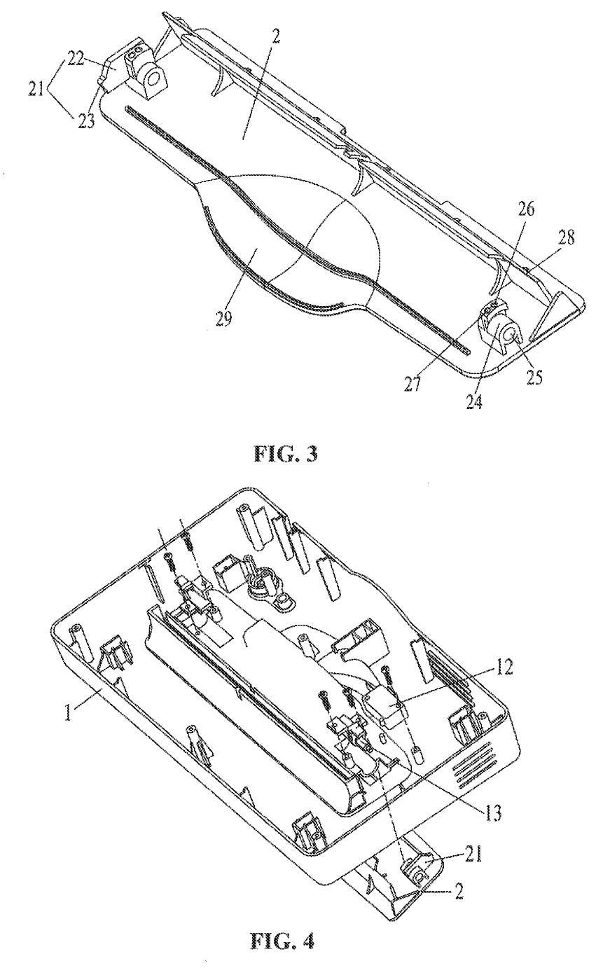

Referring to FIGS. 2 and 3, shaft bases 13 are fixed on the two opposite sides inside the paper shredder upper cover 1. The shaft bases 13 each comprise a main base body 14 and a shaft 15 protruding from the main base body 14. Corresponding to the shaft base 13, protruding blocks 24 are fixed on the opposite sides of the inner surface of the paper shredder plate 2. Within each protruding block 24, a shaft hole 25 is opened to accommodate the shaft 15.

The shaft base 13 further comprises protrusions 16 each located under the shaft 15 and provided with a protruding point 17 pointing towards the shaft 15. To match the protruding points 17, a closing detent point 26 and a working detent point 27 are provided on each protruding block 24. The protruding point 17 is accommodated in either the closing detent point 26 or the working detent point 27. The fundamental cam 22 is fixed to the protruding block 24, the cam 21 being indirectly coupled to the paper shredder plate 2.

The main base bodies 22 each have through holes. Opposite sides inside the paper shredder upper cover 1 are configured with poles. The holes and the poles are connected together by screws that go through both. Of the two opposite sides of the paper shredder plate 2, one side is configured at its inner surface with a paper stopper 28 that extends downwards and inwards, so that the paper stopper 28 faces downwards when the paper shredder plate 2 is lifted and the paper fed to be shredded can smoothly reach the shredding blade. The other side is designed with a dented pressing area 29 in the middle section of the outer surface to facilitate pressing. The safe power supply switch 12 includes through holes. The paper shredder upper cover 1 has poles at the place corresponding to the cam 21. The holes and the poles are connected together by screws that go through both.

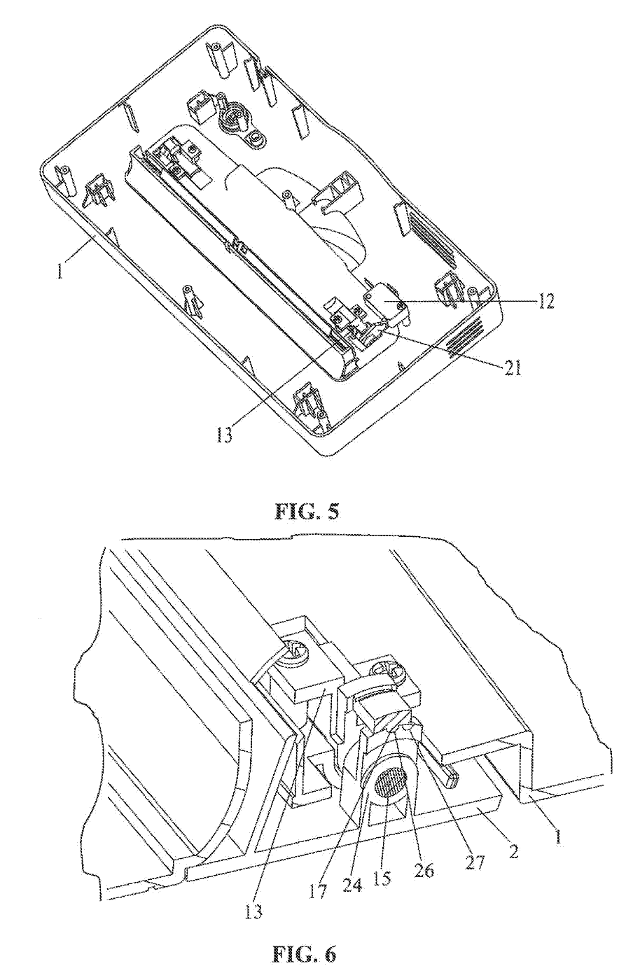

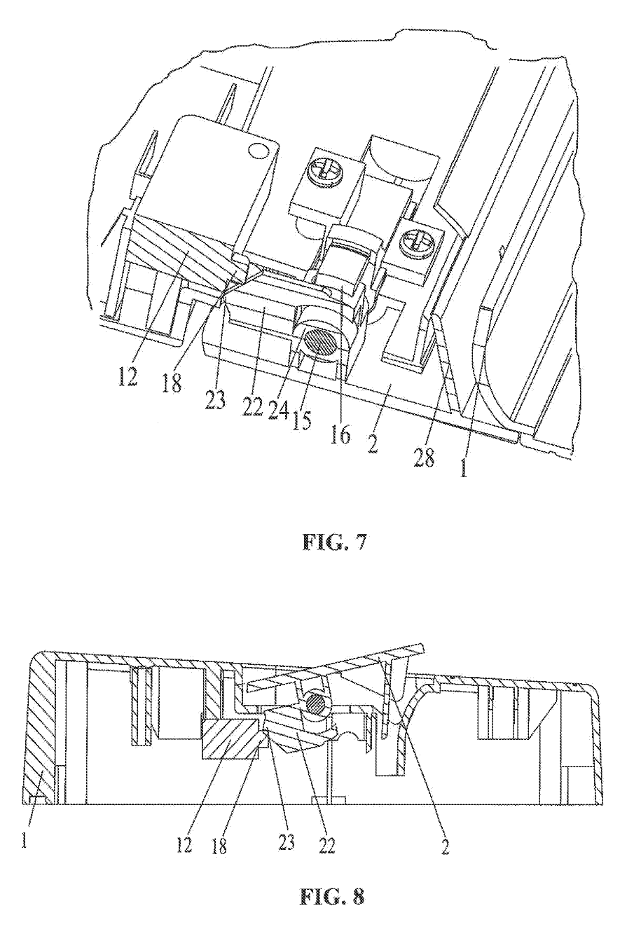

Referring to FIG. 4, the above mentioned parts are assembled in the following manner: screwing the safe power supply switch 12 inside the paper shredder upper cover 1; inserting the shaft 15 on the shaft base 13 and into the shaft hole 25 in the protruding block 24 of the paper shredder plate 2; and screwing the shaft base 13 inside the paper shredder upper cover 1. The finished assembly is shown in FIGS. 5, 6 and 7.

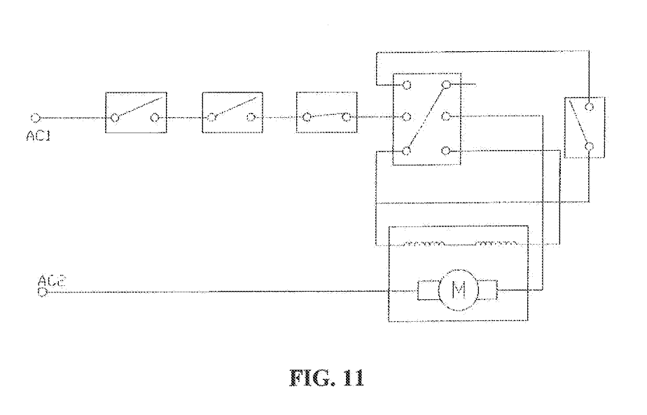

Referring to FIGS. 10 and 11, a common protection circuit of a prior art paper shredder is roughly composed of a safe switch 31 (trash can touch switch), a paper-full switch 32 (or a photic-controlled paper-full switch), a power supply flip-flop 33 (or a microcomputer-controlled inching switch) and a paper-sensitive switch 34. The safe switch 31 and the paper-full switch 32 have the first-level priority to cut off the power supply; when the paper shredder detaches from a trash can, the safe switch 31 reacts, and when the trash can is full, the paper-full switch 32 reacts; this is the normal way to protect a user. Of course, adding a switch with a pure cut-off function before the aforesaid switches, or pulling off a power supply switch, also has protective effect. In the circuit of the present invention, namely a novel safe paper feed opening structure of a paper shredder, a disconnection switch which has first-level priority is introduced before the safe switch 31 and the paper-full switch 32. In other words, the present invention adopts a safe power supply switch 12 that provides more active protection to users with the aid of a mechanical structure.

Referring back to FIG. 1, the earn 21 on the paper shredder plate 2 disengages the safe power supply switch 12 when the paper shredder plate 2 is closed. Since the safe power switch 12 has the first-level priority to cut off the power supply, it controls the power supply of the entire paper shredder. Therefore, the entire paper shredder is switched off and cannot function. Meanwhile, the paper feed opening is closed and hence is safe to users.

Referring to FIG. 8, when the paper shredder plate 2 is pressed down for paper shredding, the cam 21 on the paper shredder plate 2 presses the safe power supply switch 12. In particular, the cam point 23 presses the touch point 18; thereby the power supply is switched on and the paper shredder is electrically standing-by. A user then is able to shred paper through the paper feed opening unveiled from the paper shredder plate 2.

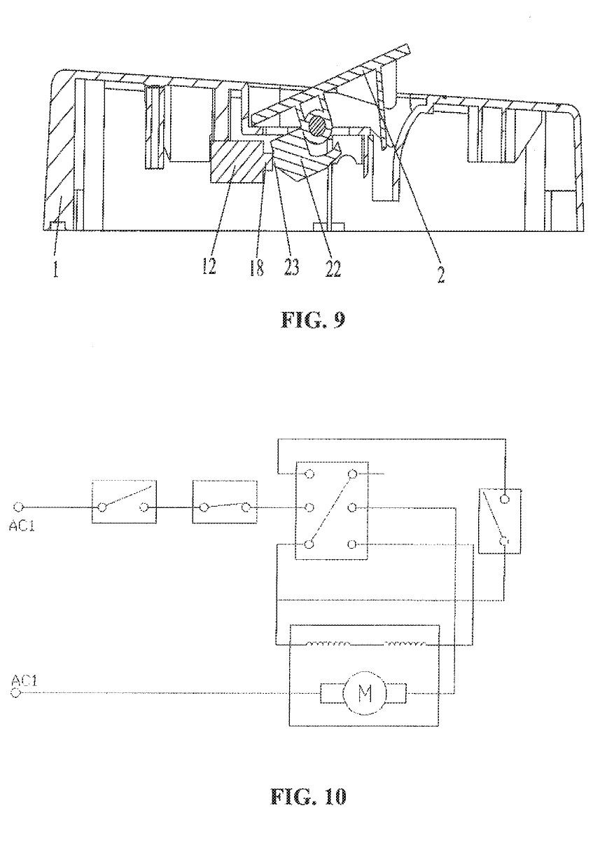

Referring to FIG. 9, in the above mentioned status, in the case where a child or a user accidentally feeds a part of his/her body or a tie wore by him/her, the paper shredder plate 2 will further turn upwards to cause the cam 21 of the paper shredder plate 2 to disengage the safe power supply 12, or in particular, to cause the earn point 23 to loose contact with the touch point 18. As mentioned above, since the safe power switch 12 has the first-level priority to cut off the power supply, the entire paper shredder is switched off and cannot function. Users and their personal belongs are therefore protected. Meanwhile, due to the adoption of a flexible closing detent point 26 and a flexible working detent point 27 on each protruding block 24 disposed on the inner surface of the paper shredder plate 2, the cam point 17 of the shaft base 13 is accommodated in the closing detent point 26 of the paper shredder plate 2 when the paper shredder plate 2 is closed, and is accommodated in the closing detent point 27 of the paper shredder plate 2 when the paper shredder plate 2 is opened. This design enables users to close and open the paper shredder plate 2 accurately.

In summary, the present invention is very simply, cleverly designed, and is easy to use. It features active protection and dual protection. Due to these characteristics, the present invention is very safe and very economical. While this specification describes the present invention in reference to the above specific embodiments, the present invention can be modified and transformed under its substantial spirit and within its substantial scope. Therefore, the specification and the drawings thereof are provided as descriptions of a preferred embodiment rather than limitations.

What is claimed is:

1. A novel safe paper feed opening structure of a paper shredder, comprising:
a paper shredder upper cover and a paper shredder plate, said shredder upper cover having an opening, and said paper shredder plate being disposed at said opening;
said paper shredder upper cover and said paper shredder plate are either integrated or separated;
wherein said paper shredder plate is configured with a touch structure/safe power supply switch, and said paper shredder upper cover is correspondingly configured with a safe power supply switch/touch structure, said touch structure and said safe power supply switch being designed to interact with each other.

2. The novel safe paper feed opening structure of a paper shredder according to claim 1, wherein:
said touch structure and said safe power supply switch are integrated into one circuit disconnection device that serves to protect by actively cutting off the power supply whenever a non-expected item is fed in, and which functions reversely as a passive conducting device when paper is fed through the paper feed opening.

3. The novel safe paper feed opening structure of a paper shredder according to claim 1, wherein:
said safe power supply switch is a preferential disconnection device, which, different from a safe switch or a paper-full switch, whose function is realized by adopting a flip-flop in a circuit of a paper shredder, has the first-level priority to cut off the circuit in order to protect a user.

4. The novel safe paper feed opening structure of a paper shredder according to claim 1, wherein:
said paper shredder upper cover and said paper shredder plate refer to any separate or integrated structures able to seal said paper feed opening.

5. The novel safe paper feed opening structure of a paper shredder according to claim 1, wherein:
said paper shredder plate and said paper shredder upper cover are such connected that the former can move separately relative to the latter; said touch structure is a cam disposed on said paper shredder plate; corresponding to said cam, said safe power supply switch is disposed on a corresponding position of said paper shredder upper cover; said cam and said safe power supply switch are configured to interact with each other.

6. The novel safe paper feed opening structure of a paper shredder according to claim 5, wherein:
said opening is a dented opening disposed on said paper shredder upper cover; said paper shredder plate locates at said dented opening; said cam is disposed on the inner surface of said paper shredder plate; and said safe power supply switch is disposed on said paper shredder upper cover.

7. The novel safe paper feed opening structure of a paper shredder according to claim 5, wherein:
said cam comprises a fundamental cam and a cam point on said fundamental cam, said fundamental earn being fixed on the, paper shredder plate, and said cam point interacting with said touch point of said safe power supply switch.

8. The novel safe paper feed opening structure of a paper shredder according to claim 5, wherein:
shaft bases are fixed on the two opposite sides inside said paper shredder cover, each comprising a main base body and a shaft protruding from said main base body; said protruding blocks are correspondingly fixed on the opposite sides of the inner surface of said paper shredder paper shredder plate; within each of said protruding blocks, a shaft hole is opened to accommodate said shaft.

9. The novel safe paper feed opening structure of a paper shredder according to claim 8, wherein:
said shaft base further comprises protrusions each located under said shaft and provided with a protruding point pointing towards said shaft; to match said protruding points, a closing dent point and a working dent point are provided on each protruding block; said protruding point is accommodated in either said closing dent point or said working dent point.

10. The novel safe paper feed opening structure of a paper shredder according to claim 9, wherein:
said fundamental earn is fixed to said protruding block, whereby said cam is indirectly fixed to said paper shredder plate.

11. The novel safe paper feed opening structure of a paper shredder according to claim 8, wherein:
said main base bodies each have through holes; the opposite sides inside said paper shredder upper cover are configured with poles; said holes and said poles are connected together by screws that go through both.

12. The novel safe paper feed opening structure of a paper shredder according to claim 1, wherein:
of the two opposite sides of said paper shredder plate, one side is configured at its inner surface with a paper stopper that extends downwards and inwards, and the other side is designed with a dent pressing area in the middle section of said outer surface.

13. The novel safe paper feed opening structure of a paper shredder according to claim 1, wherein:
said safe power supply switch includes through holes; inside, said paper shredder upper cover has poles at the place corresponding to said touch structure; said holes and said poles are connected together by screws that go through both.
